(19) United States
(12) Patent Application Publication
(10) Pub. No.: US 2003/0164465 A1
(43) Pub. Date: Sep. 4, 2003

(54) Method and apparatus for producing foam

(76) Inventors: John Bureaux, Orleans (CA); Roger Sabourin, New Market (CA)

Correspondence Address: George Seaby, Seaby & Associates, 603-880 Wellington Street, Ottawa, ON, K1R 6K7, CA

(21) Appl. No.: 10/275,434

(22) PCT Filed: May 11, 2001
(86) PCT No.: PCT/CA01/00668

(51) Int. Cl. A62D 1/00

(52) U.S. Cl. 252/3

(57) ABSTRACT

Foam carrying a decontaminating/oxidizing agent is produced by introducing air under pressure into a pair of tanks (10, 11) carrying a foam forming solution and a solution of the agent. The tanks (10, 11) are connected to an air passage (2) through a manifold (1) for introducing the foam solution and then the agent solution into the air passage (2) to produce foam bubbles coated with agent for discharge under pressure through a hose (19) connected to said air passage (2). Alternatively, the two solutions are mixed in a single tank (22) connected to a source of air (23) under pressure, and the resulting mixture is discharged through a hose (37) and a foam-forming nozzle (40) at the discharge end of the hose (37).

This invention relates to a method and apparatus for producing foam. Specifically, the invention relates to a method and apparatus for producing a foam for use in explosive blast suppression.

Aqueous foam enclosed in a barrier structure has been employed in explosive blast suppression. Examples of such a structure are disclosed by U.S. Pat. No. 5,225,622, issued to Guy L. Gettle et al on Jul. 6, 1993 and U.S. Pat. No. 5,394,786, issued to Guy L. Gettle et al on Mar. 7, 1995. In the first patent, foam expansion under a dome occurs at a very high rate, i.e. 135:1 to 1000:1, which causes instability and early foam breakdown.

When a blast occurs under aqueous foam, as each bubble bursts, there is an incremental loss of the blast overpressure energy, the net effect of millions of bubbles being destroyed representing a significant blast reduction. Working from the premise that the suppressant quality of the foam is a function of the mechanical generation and strength of the bubble, the inventors have found that superior blast suppression can be achieved by employing compressed air to deliver the aqueous foam to the target, and by employing a selected aqueous high stability flowable foam material having a low expansion ratio and low drainage rate properties.

It is believed that a critical mass of water in the foam is necessary for optimum blast suppression of a certain charge. The critical mass of water is the amount of water contained in the foam. It is believed that a certain amount of water is required, because, upon standing, the water tends to drain from the foam, increasing its expansion to levels which make the foam ineffective. In order to maintain the critical mass of water, a low drainage rate foam is required. A relatively low expansion rate is also required. However, if the expansion rate is too low, the foam behaves like a liquid, while at a very high expansion rate, it behaves like a gas. It is believed that somewhere in between there are optimal foam characteristics, i.e. a proper combination of expansion ratio and low drainage rate which is required for optimal blast suppression.

Foam production is a dynamic process, and nascent (freshly made) foam has a certain expansion ratio and a drainage rate which keep changing with time. As water drains out of the foam, the expansion of the foam increases. At a certain point in time, so much drainage has occurred that the foam becomes ineffective in blast suppression. This can be remedied by incorporating polymers or stabilizers in the foam concentrate to slow up the drainage. However, there is a limit to the amount of polymers or stabilizers that can be incorporated in a foam forming composition.

The key to the production of an effective foam for blast suppression is to produce a foam with a very slow drainage rate at a certain expansion ratio, related to a critical mass of water in the foam forming solution. Foam are also used in surface decontamination operations. It is known that some decontaminating agents react with foaming ingredients and stabilizers rendering them ineffective. This accelerates the drainage rate.

Although the use of foam as a stand alone blast suppressant using air aspirating foam nozzles is very effective, the foam tends to lose its effectiveness when used in conjunction with decontaminating agents.

An object of the invention is to provide a method and apparatus for producing a foam having improved blast suppression capability.

Another object of this invention is to provide an apparatus for producing foam from a foam solution/decontaminating agent combination using pressurized air which produces foam with extremely slow drainage rates; thereby retaining all of its blast suppression capability.

A foam expansion ratio in the range of 17:1 to 19:1 satisfies the above-identified requirement.

According to one aspect the invention provides an apparatus for producing foam comprising:

(a) a first tank carrying foam forming solution;

(b) a second tank carrying decontaminating/oxidizing agent;

(c) a source of gas under pressure for pressurizing said first and second tanks to cause the dispensing of the contents of said tanks;

(d) a manifold connecting said source of gas to said first and second tanks;

(e) a nozzle connected to said manifold for discharging fluid under pressure from said manifold;

(f) a first passage through said manifold for carrying gas from said source of gas to said nozzle;

(g) a second passage in said manifold communicating with said first passage for carrying gas from said source to said first tank and second tanks;

(h) a third passage in said manifold connecting said first tank to said first passage for carrying foam forming solution to said first passage; and

(i) a fourth passage in said manifold connecting said second tank to said first passage for carrying decontaminating/oxidizing agent to said first passage;

whereby, when air under pressure is introduced into said manifold and said tanks, foam forming solution and agent flow into said first passage and are discharged through said nozzle in the form of an agent-containing foam.

According to another aspect, the invention provides an apparatus for producing foam comprising:

(a) a tank for carrying foam forming solution containing a decontaminating/oxidizing agent;

(b) a source of gas under pressure connected to said tank for pressurizing the container to cause the solution to flow therefrom;

(c) a solution dispersing hose having one end connected to said tank for discharging solution from the tank; and

(d) a foam forming nozzle on said second end of said dispensing line for creating and discharging foam from the apparatus.

According to a third aspect, the invention relates to a method of producing foam comprising the steps of:

(a) creating a stream of gas under pressure in a first passage through a manifold;

(b) causing a foam forming solution to enter said gas stream to create a foam;

(c) introducing a decontaminating/oxidizing agent into the foam in said first passage to coat individual bubbles in said foam; and

(d) discharging the foam from the manifold to cause expansion of the decontaminating/oxidizing agent-carrying foam.

The invention is described below in greater detail with reference to the accompanying drawings, in which:

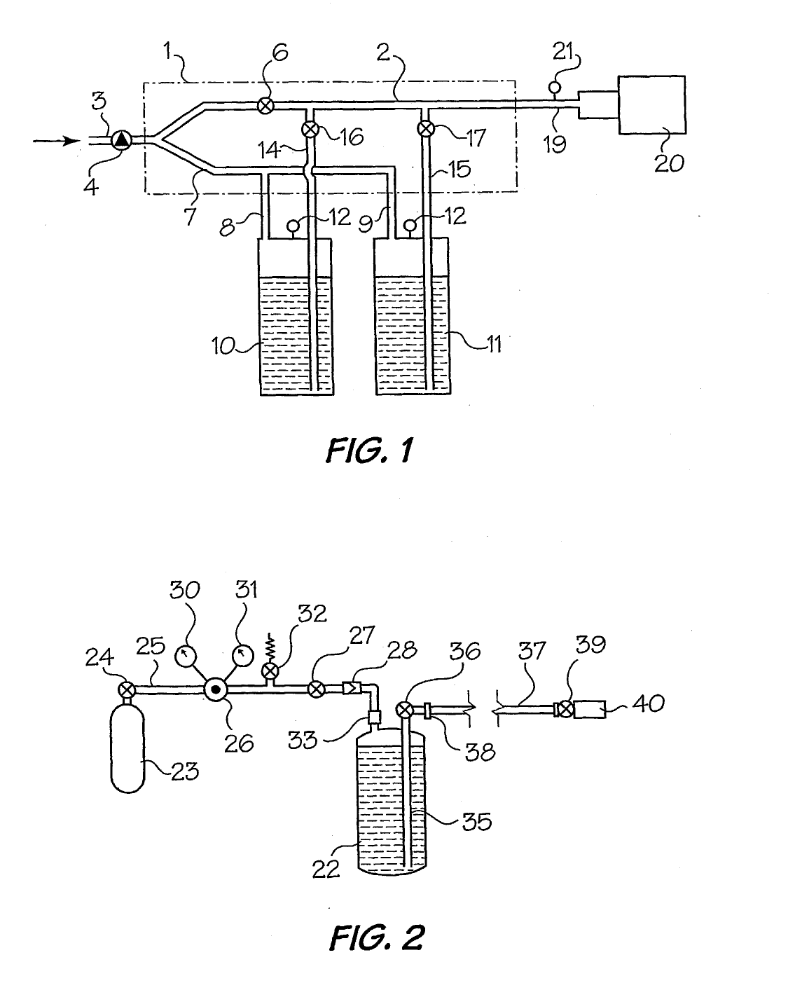

FIG. 1 is a schematic flow diagram of an apparatus according to one embodiment of the invention; and

FIG. 2 is a schematic flow diagram of an apparatus according to a second embodiment of the invention.

With reference to FIG. 1, an apparatus in accordance with the invention includes a manifold 1 with a passage 2 therethrough. Compressed air from a source thereof (not shown) is introduced into the manifold 1 via an inlet line 3 containing a pressure regulator 4. The source of compressed air can be a regulated storage tank or a compressor. Air flow through the passage 2 is controlled by a valve 6 in the manifold 1 downstream of the inlet line 3 in the direction of air flow through the passage 2.

A second passage 7 connected to inlet line 3 carries air to air inlets 8 and 9 in a pair of tanks 10 and 11, respectively for pressurizing the tanks. The first tank 10 carries a foam solution, and the second tank 11 dispenses a decontaminating/oxidizing agent (hereinafter deconlox agent). Gauges 12 monitor the air pressure in the tanks 10 and 11. Solution from the tank 10 and deconlox agent from the tank 11 are delivered to the passage 2 via lines 14 and 15. Valves 16 and 17 in the lines 14 and 15, respectively control the flow of liquid from the tanks 10 and 11 to the passage 2.

A mixture of foam solution and decon/ox agent is discharged from the manifold 1 via an outlet hose 19 and a nozzle 20. A gauge 21 monitors pressure in the hose 19.

In operation, with the passage 2 pressurized, the valves 16 and 17 are opened to feed foam solution and decon/ox agent to the passage 2. Air mixing with the foam solution in the passage 2 results in the formation of a foam with a specific bubble size or expansion depending upon the volume of air versus the volume of liquid entering the manifold 1. By adjusting the ratio of air to solution, the nature of the foam bubbles can be altered. A fixed volume of air at a given pressure produces a specific volume of foam bubbles per liter of foam solution. The longevity of the foam bubbles is based on the energy used to form the bubbles and the dryness of the bubbles. The performance of the bubbles is determined by observing the expansion rate and the rate of drainage of liquid from the bubbles.

Decon/ox agent from the tank 11 is injected into the foaming solution in the passage 2 via the line 15 and the valve 17. The agent is injected after foaming has started or simultaneously with the feed of solution from the tank 10. By introducing the decon/ox agent directly into the foam in the manifold 2, the surfaces of the foam bubbles are coated with agent. Thus, the slower draining foam bubble structures deliver the agent to a chemical or biological hazard in a relatively effective manner. The agent on the bubbles immediately contacts the hazard and initiates oxidation. This method reduces the effect of the oxidizing agent on the foam bubbles, while increasing the effectiveness of the agent. Moreover, increased longevity of foam bubbles reduces the entry of harmful vapors into the atmosphere for air current spreading. When applied as an explosive containment, the slower drain time of the foam solution provides improved safety for persons using the apparatus, because the need for haste due to bubble collapse is reduced or eliminated.

A suitable flowable, absorbing, aqueous, energy foam material is described in U.S. Pat. No. 4,770,794, issued to Edward Cundasawmy et al on Sep. 18, 1988. A particularly useful foam material of this nature comprises 1-3% active foam forming ingredients, the balance being water, and the material having an expansion ratio of 17:1 to 49:1. Such foams exhibit good stability and drainage properties, and can be used in relatively small amounts. The foam is discharged at a flow rate of 40-80 US gallons/minute, preferably 40-60 US gallons per minute.

### EXAMPLE 1

A prototype manifold 1 was prepared and mounted on an approximately 5 liter pressure vessel. A solution of approximately 1.5% Silvex®) (see U.S. Pat. No. 4,770,794 mentioned above) to water was placed in the vessel. Compressed air foam was generated at an expansion ratio of 40:1 (the volume of the foam was 40 times the volume of the solution). Physical properties of the foam were assessed (based on visually examining the product) as being superior for blast when compared to the traditional air aspirated foam. A blast test was conducted by placing a sampling of the foam over an electric detonator (blasting cap). The detonator was fired and the resulting effect was suppressed considerably.

A pressurized air cylinder or a compressor to generate the foam bubble provides a uniform bubble size, slower drain time of the solution from the bubble (zero solution drainage after 30 minutes compared to 25% drained solution in approximately 8 minutes when an air aspirating nozzle is used) structure and the introduction of the decon solution at the source of bubble generation.

Although Silvex® has been used to illustrate the operation of the invention, it will be appreciated by those skilled in the art that many other foam materials may also be used, including those containing biological/chemical decontaminating agents, provided that they are formulated to exhibit the requisite expansion ratio and other related properties discussed above.

Referring to FIG. 2, in a second embodiment of the apparatus of the present invention, foaming solution and decon/ox agent are mixed in a single tank 22. The use of a single tank 22 simplifies the method and apparatus of the invention. An operator merely pours the desired chemicals into the tank 22, and adds the appropriate quantity of water. The filling action usually results in adequate mixing of the chemicals and water.

The system is pressurized by feeding air under pressure to the tank 22 from a high pressure air cylinder 23 via a valve 24, and a hose 25. The hose 25 contains a regulator 26, a quarter-turn valve 27 and a one-way check valve 28. High and low pressure gauges 30 and 31 monitor air pressure in the line 25, and a pressure relief valve 32 releases excess pressure from the hose 25. The hose 25 is connected to the tank 22 by a quick disconnect 33.

Chemicals are discharged from the tank 22 via line 35 containing a valve 36. The line 35 is connected to a long hose 37 (in the embodiment shown, a twenty-five foot fire hose) by a coupler 38. The foamed solution is discharged from the hose 37 through a D-handle valve 39 and a nozzle 40. The nozzle 40 forms the foam during discharge of solution therethrough. A suitable foam generating nozzle is described In U.S. Pat. No. 6,173,908, issued to John G. Bureaux et al on Jan. 16, 2001. Depending upon the application, foam expansion ratios of 5:1 to 49:1 are employed. The application also dictates the size of the nozzle 40.

A 6″ diameter nozzle is used for dispersal suppressant foam (DSF) and decontamination dispersal suppressant foam (DDSF) applications, and a 2″ diameter nozzle is used for surface decontaminant foams (SDF). While DSF does not include a chemical or biological decontaminate, DDSF and SDF contain such an agent. No enclosure is used for SDF applications, and the foam expansion rate is typically in the range of 5:1 to 20:1. For DSF and DDSF applications, the expansion ratio is typically in the 10:1 to 49:1 range. In the DSF and DDSF applications, a small (approximately 1.5 m diameter) dome is employed.

### EXAMPLE 2

Using the apparatus of FIG. 2, the air cylinder 23 was charged to approximately 3000 psi, and the relief valve 32 was set at approximately 100 psi. The volume of the tank 22 was 142 liters. The above-mentioned foam forming solution and expanding ratio were used. The system was tested in the DSF mode, i.e. without any decontamination agent, and successfully mitigated the blast from up to 8 ounces of C4 explosive enclosed in a 1.5 meter diameter dome-shaped tent having an enclosure volume of approximately 50 ft³.

We claim:

1. An apparatus for producing foam consisting essentially of:
(a) a tank (22) for carrying foam forming solution containing a decontaminating/oxidizing agent;
(b) a source (23) of gas under pressure connected to said tank (22) for pressurizing the tank (22) to cause the solution to flow therefrom;
(c) a solution dispersing hose (37) having one end connected to said tank (22) for discharging solution from the tank (22), characterized in that
(d) a foam forming nozzle (40) is provided on a second end of said dispensing hose (27) for creating and directly discharging foam from the apparatus.

2. An apparatus according to claim 1, including:
(e) an inlet hose (25) connecting said tank (22) to said source of gas (23);
(f) a pressure regulator (26) in said inlet hose (25);
(g) a first valve (27) in said inlet hose (25) downstream of said pressure regulator (26) in the direction of gas travel for controlling the flow of gas to said tank (22); and
(h) a second, one-way valve (28) in said inlet hose (25) between said first valve (27) and said tank (22) for preventing the gas flow from said tank (22) in the direction of said source (23).

3. A method of producing foam for explosive blast suppression consisting of the steps of:
(a) creating a stream of gas under pressure in an inlet hose (25);
(b) introducing said gas under pressure into a tank (22) carrying foam forming solution for pressurizing the tank (22) to cause solution to flow therefrom;
(c) conveying solution discharged from the tank (22) through a dispensing hose (37), characterized in that
(d) the solution from the dispensing hose (37) is discharged through a foam forming nozzle (40) to create and directly discharge foam under pressure.

4. A method according to claims 3, wherein the gas introduced into the tank (22) is under a pressure of 100 psi, and the flow rate of foam discharged from the noble (40) is 40 to 80 US gallons per minute.
